(19) United States
(12) Patent Application Publication
(10) Pub. No.: US 2024/0215119 A1
(43) Pub. Date: Jun. 27, 2024

(54) HEATER ELEMENT FOR VEHICLE AIR CONDITIONING

(71) Applicant: NGK INSULATORS, LTD., Nagoya-City (JP)

(72) Inventor: Yoshiki KONNO, Tajimi-Shi (JP)

(73) Assignee: NGK INSULATORS, LTD., Nagoya-City (JP)

(21) Appl. No.: 18/508,540

(22) Filed: Nov. 14, 2023

(30) Foreign Application Priority Data
Dec. 26, 2022 (JP) 2022-208617

(51) Int. Cl. H05B 3/42

(52) U.S. Cl. CPC H05B 3/42

(57) ABSTRACT

A heater element for vehicle air conditioning includes: a honeycomb structure having: a plurality of pillar shaped honeycomb segments each having an outer peripheral wall and partition walls disposed on an inner side of the outer peripheral wall, the partition walls defining a plurality of cells, each of the cells extending from a first end face to a second end face to form a flow path; and joining layers for joining surfaces of the outer peripheral walls of the plurality of pillar shaped honeycomb segments parallel to an extending direction of the cells; and a pair of electrodes provided on surfaces of the outer peripheral wall, the partition walls and the joining layers on the first end face and the second end face. The partition walls have a thickness of 0.1016 to 0.1397 mm. The joining layers have a thickness of 1.0 to 5.0 mm.

### CROSS REFERENCE TO RELATED APPLICATIONS

The present invention claims the benefit of priority to Japanese Patent Application No 2022-208617 filed on Dec. 26, 2022 with the Japanese Patent Office, the entire contents of which are incorporated herein by reference in its entirety.

### FIELD OF THE INVENTION

The present invention relates to a heater element for vehicle air conditioning.

### BACKGROUND OF THE INVENTION

In various types of vehicles such as automobiles, there are increasing requirements for improvement of vehicle interior environment. Specific requirements include reduction of an amount of CO₂ in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problems, Patent Literatures 1 and 2 disclose a vehicle air conditioning system in which components to be removed such as CO₂ and water vapor in the air in the vehicle interior are trapped by a functional material such as an adsorbent, and the components to be removed are then allowed to react or desorbed by heating to discharge them to the outside of the vehicle and regenerate the functional material. Such a vehicle air conditioning system requires more contact between the air and the functional material in order to ensure the performance of trapping the components to be removed, and the ability of the functional material to be heated to a predetermined temperature in order to facilitate the regeneration of the functional material. The regeneration can be carried out, for example, by removing substances adsorbed on the functional material through an oxidation reaction, and by desorbing and releasing the substances adsorbed on the functional material, but both cases require the heating of the functional material at an appropriate temperature depending on the adsorbed substances.

On the other hand, Patent Literature 3 discloses a heater element, including: a pillar shaped honeycomb structure having an outer peripheral wall and partition walls disposed on an inner side of the outer peripheral wall and defining a plurality of cells forming flow paths from a first end face to a second end face, wherein the partition walls have a PTC property, the partition walls have a thickness of 0.13 mm or less, and the first end face and the second end face have an opening ratio of 0.81 or more. This heater element is used for heating a vehicle interior, and is an efficient heating means. Therefore, the use of such a heater element as a support for the functional material can contribute to the shortening of the regeneration time of the functional material. In particular, it is believed that since this heater element can be heated by electric conduction and has a PTC property, it can easily heat the functional material, while suppressing excessive heat generation and thermal deterioration of the functional material.

In the heater element described in Patent Literature 3, the temperature increase time (regeneration time of the functional material) could be shortened because the thickness of the partition walls of the honeycomb structure is 0.13 mm or less so that the heating area is increased.

However, if the thickness of the partition walls of the honeycomb structure is smaller, the widths of the pair of electrodes provided on the surfaces of the partition walls on the first end face and the second end face of the honeycomb structure will become small, so that electrical resistance will be increased and the temperature increase time cannot be sufficiently shortened.

The present invention was made to solve the problems as described above. An object of the present invention is to provide a heater element for vehicle air conditioning, which can suppress an increase in electrical resistance and shorten the temperature increase time even if the thickness of the partition walls of the honeycomb structure is small.

### PRIOR ART

### Patent Literatures

[Patent Literature 1] Japanese Patent Application Publication No. 2020-104774 A
[Patent Literature 2] Japanese Patent Application Publication No. 2020-111282 A
[Patent Literature 3] WO 2020/036067 A1

### SUMMARY OF THE INVENTION

As a result of extensive studies for structures of heater elements for vehicle air conditioning, the present inventors have found that the above problems can be solved by using a honeycomb structure in which a plurality of pillar shaped honeycomb segments are joined via joining layers, and controlling the thicknesses of the partition walls of the pillar shaped honeycomb segments and the joining layers within specific ranges, and they have completed the present invention. That is, the present invention is illustrated as follows:

(1)

A heater element for vehicle air conditioning, comprising:

a honeycomb structure comprising: a plurality of pillar shaped honeycomb segments each having an outer peripheral wall and partition walls disposed on an inner side of the outer peripheral wall, the partition walls defining a plurality of cells, each of the cells extending from a first end face to a second end face to form a flow path; and joining layers for joining surfaces of the outer peripheral walls of the plurality of pillar shaped honeycomb segments parallel to an extending direction of the cells; and

a pair of electrodes provided on surfaces of the outer peripheral wall, the partition walls and the joining layers on the first end face and the second end face;

wherein the partition walls have a thickness of 0.1016 to 0.1397 mm, and the joining layers have a thickness of 1.0 to 5.0 mm.

(2)

The heater element for vehicle air conditioning according to (1), wherein the pillar shaped honeycomb segments have an opening ratio of 71.7 to 80.3%.

(3)

The heater element for vehicle air conditioning according to (1) or (2), wherein a ratio of areas of the joining layers to an area of the first end face or the second end face of the honeycomb structure is more than or equal to 1.9% and less than 28.6%.

(4)

The heater element for vehicle air conditioning according to any one of (1) to (3), wherein the partition walls are made of a material containing barium titanate as a main component.

(5)

The heater element for vehicle air conditioning according to (4), wherein the pair of electrodes are made of a material having a lower electrical resistance than that of the barium titanate.

(6)

The heater element for vehicle air conditioning according to any one of (1) to (5), further comprising a functional material-containing layer provided on surfaces of the partition walls parallel to an extending direction of the cells.

(7)

The heater element for vehicle air conditioning according to (6), wherein the functional material-containing layer comprises a functional material having a function of adsorbing one or more selected from water vapor, carbon dioxide, and volatile components.

(8)

The heater element for vehicle air conditioning according to (6) or (7), wherein the functional material-containing layer comprises a catalyst.

### BRIEF DESCRIPTION OF THE DRAWINGS

FIG. 1A is a schematic view of a cross section of a heater element according to an embodiment of the invention, which is parallel to an extending direction of cells (flow path);

FIG. 1B is a schematic cross-sectional view taken along the line a-a′ in FIG. 1A;

FIG. 2A is a schematic view of a cross section of a heater element according to another embodiment of the invention, which is parallel to an extending direction of cells (flow path);

FIG. 2B is a schematic cross-sectional view taken along the line b-b′ in FIG. 2A;

FIG. 3 is a schematic view of a cross section of a heater element according to another embodiment of the present invention, which is orthogonal to an extending direction of cells (flow path); and

FIG. 4 is a schematic view of a cross section of a heater element according to another embodiment of the present invention, which is orthogonal to an extending direction of cells (flow path).

### DETAILED DESCRIPTION OF THE INVENTION

A heater element for vehicle air conditioning according to an embodiment of the present invention (which is, hereinafter, abbreviated as a “heater element”) includes: a honeycomb structure including: a plurality of pillar shaped honeycomb segments each having an outer peripheral wall and partition walls disposed on an inner side of the outer peripheral wall, the partition walls defining a plurality of cells, each of the cells extending from a first end face to a second end face to form a flow path; and joining layers for joining surfaces of the outer peripheral walls of the plurality of pillar shaped honeycomb segments parallel to an extending direction of the cells; and a pair of electrodes provided on surfaces of the outer peripheral wall, the partition walls and the joining layers on the first end face and the second end face. The partition walls have a thickness of 0.1016 to 0.1397 mm. The joining layers have a thickness of 1.0 to 5.0 mm. With such a configuration, even if the thickness of the partition wall is small, an increase in electrical resistance can be suppressed due to the presence of the joining layers that are thicker than the partition walls, so that the temperature increase time can be shortened.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### (1. Heater Element)

The heater element according to an embodiment of the present invention can be suitably utilized as a heater element for use in a vehicle air conditioning system for various vehicles such as automobiles. The vehicle includes, but not limited to, automobiles and trains. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The heater element according to the embodiment of the present invention can be particularly suitably used for a vehicle having no internal combustion engine such as electric vehicles and electric railcars.

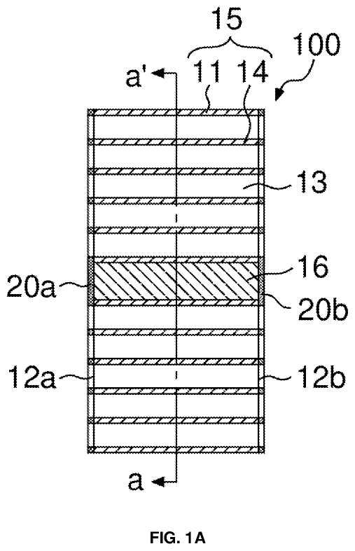

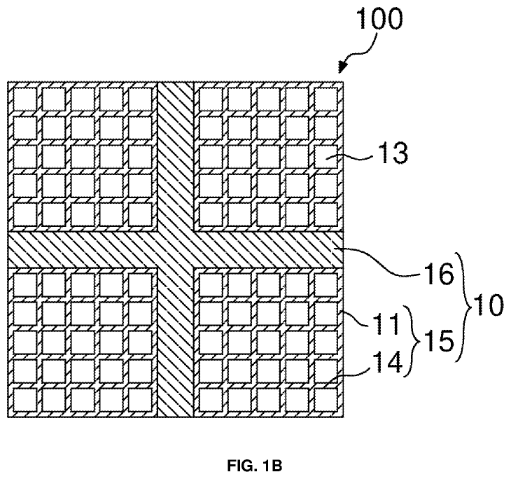

FIG. 1A is a schematic view of a cross section of a heater element according to an embodiment of the invention, which is parallel to an extending direction of cells (flow path). Further, FIG. 1B is a schematic view of the line a-a′ in FIG. 1A.

As shown in FIGS. 1A and 1B, a heater element 100 includes: a honeycomb structure 10 and a pair of electrodes 20a, 20b. The honeycomb structure 10 includes: a plurality of pillar shaped honeycomb segments 15 each having an outer peripheral wall 11 and partition walls 14 disposed on an inner side of the outer peripheral wall 11 and defining a plurality of cells 13 to form flow paths each extending from a first end face 12a to a second end face 12b; and joining layers 16 for joining surfaces of the outer peripheral walls 11 of the plurality of pillar shaped honeycomb segments 15 parallel to an extending direction of the cells 13. The pair of electrodes 20a, 20b are provided on surfaces of the outer peripheral wall 11, the partition walls 14 and the joining layers 16 on the first end face and the second end face.

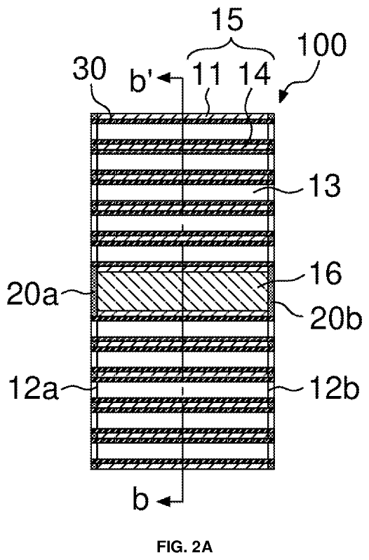

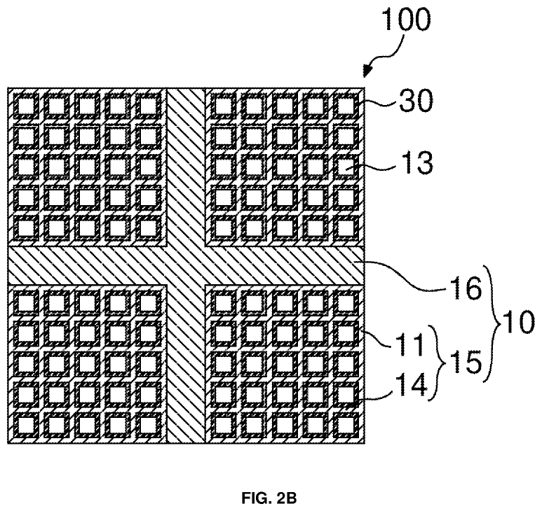

The heater element 100 can be used as a support (carrier) for forming a functional material-containing layer. FIG. 2A shows a schematic view of a cross section with the functional material-containing layer formed on the heater element 100, which is parallel to the extending direction of the cells 13 (flow path), FIG. 2B is a schematic cross-sectional view taken along the line b-b′ in FIG. 2A. It should be noted that FIGS. 2A and 2B have the same configurations as those of FIGS. 1A and 1B with the exception that the functional material-containing layer is formed.

As shown in FIGS. 2A and 2B, the heater element 100 further includes a functional material-containing layer 30 provided on the surfaces of the partition walls 14 parallel to the extending direction of the cells 13.

Each member forming the heater element 100 will be described below in detail.

### (1-1. Honeycomb Structure)

### <Pillar Shaped Honeycomb Segment>

Each of the pillar shaped honeycomb segments 15 making up the honeycomb structure 10 has an outer peripheral wall 11 and partition walls 14 disposed on an inner side of the outer peripheral wall 11, the partition walls 14 defining a plurality of cells 13, each of the cells 13 extending from a first end face 12a to a second end face 12b to form a flow path.

The shape of the pillar shaped honeycomb segment 15 is not particularly limited, but it is such that an outer shape of a cross section of the honeycomb structure 10 orthogonal to the flow path direction (the extending direction of the cells 13) can be polygonal such as quadrangular (rectangular, square), pentagonal, hexagonal, heptagonal, and octagonal. With such a shape, the surfaces of the outer peripheral walls 11 parallel to the extending direction of the cells 13 of the plurality of pillar shaped honeycomb segments 15 can be easily joined together by a joining layers 16. The end faces (first end face 12a and second end face 12b) of the pillar shaped honeycomb segment have the same shape as the cross section.

The shape of each cell 13 of the pillar shaped honeycomb segment 15 is not particularly limited, but it may be polygonal such as quadrangular (rectangular, square), pentagonal, hexagonal, heptagonal, and octagonal, circular, or oval in the cross section of the pillar shaped honeycomb segment 15 orthogonal to the flow path direction. These shapes may be alone or in combination of two or more. Moreover, among these shapes, the quadrangle or the hexagon is preferable. By providing the cells 13 having such a shape, it is possible to reduce the pressure loss when the air flows.

It should be noted that FIGS. 1A, 1B, 2A and 2B show, as an example, a honeycomb structure 10 in which the outer shape of the cross section and the shape of each cell 13 are quadrangular in the cross section orthogonal to the flow path direction of the pillar shaped honeycomb segment 15.

The partition walls 14 of the pillar shaped honeycomb segment 15 has a thickness of 0.1016 to 0.1397 mm (4.5 to 5.5 mil), and preferably 0.1143 to 0.1270 mm (4.5 to 5.0 mil). By controlling the thickness of the partition walls 14 within such a range, a heating area (a contact area with an air flowing through the cells 13) is increased, so that a temperature increase time (a regeneration time of the functional material) can be shortened. Furthermore, an amount of the functional material supported can also be increased.

As used herein, the thickness of the partition walls 14 refers to a length of a line segment that is across the partition wall 14 when connecting the centers of gravity of adjacent cells 13 with the line segment in the cross section orthogonal to the flow path direction of the pillar shaped honeycomb segment 15. The thickness of the partition walls 14 refers to an average thickness of all the partition walls 14.

Although the thickness of the outer peripheral wall 11 of the pillar shaped honeycomb segment 15 is not particularly limited, it is preferably 0.05 to 0.1 mm, and more preferably 0.06 to 0.5 mm, and even more preferably 0.08 to 0.4 mm, and still more preferably 0.08 to 0.3 mm. By controlling the thickness of the outer peripheral wall 11 within such a range, the pressure loss when the air flows through the cells 13 can be reduced while ensuring the strength of the pillar shaped honeycomb segments 15.

As used herein, the thickness of the outer peripheral wall 11 refers to a length from a boundary between the outer peripheral wall 11 and the outermost cell 13 or partition wall 14 to a side surface of the pillar shaped honeycomb segment 15 in a normal line direction of the side surface in the cross section orthogonal to the flow path direction of the pillar shaped honeycomb segment 15.

The cell density of the pillar shaped honeycomb segment 15 is not particularly limited, but it is preferably 2.54 to 140 cells/cm², and more preferably 15 to 100 cells/cm², or 20 to 90 cells/cm². By controlling the cell density within such a range, the pressure loss when the air flows through the cells 13 can be easily reduced while ensuring the strength of the pillar shaped honeycomb segments 15.

As used herein, the cell density refers a value obtained by dividing a number of cells by an area of one end face (first end face 12a or second end face 12b) of the pillar shaped honeycomb segment 15 (the total area of the partition walls 14 and the cells 13 excluding the outer peripheral wall 11).

The cell pitch of the pillar shaped honeycomb segment 15 is not particularly limited, but it is preferably 1.0 to 2.0 mm, and more preferably 1.1 to 1.8 mm, and still more preferably 1.2 to 1.6 mm. By controlling the cell pitch within such a range, the pressure loss when the air flows through the cells 13 can be easily reduced while ensuring the strength of the pillar shaped honeycomb segments 15.

As used herein, the cell pitch refers to a value obtained by the following calculation. First, the area of one end face (first end face 12a or second end face 12b) of the pillar shaped honeycomb segment 15 (the total area of the partition walls 14 and the cells 13 excluding the outer peripheral wall 11) is divided by the number of the cells to calculate an area per a cell. A square root of the area per a cell is then calculated, and this is determined to be the cell pitch.

The opening ratio of the pillar shaped honeycomb segment 15 is not particularly limited, but it is 71.7 to 80.3%, and preferably 72.6 to 76.0%. By controlling the opening ratio of the pillar shaped honeycomb segment 15 within such a range, the pressure loss when the air flows through the cells 13 can be easily reduced while ensuring the strength of the pillar shaped honeycomb segments 15.

As used herein, the opening ratio of the pillar shaped honeycomb segment 15 refers a value obtained by dividing the total area of the cells 13 defined by the partition walls 14 by the area of one end face 12b (first end face 12a or second end face 12b) (the total area of the partition walls 14 and the cells 13 excluding the outer peripheral wall 11) in the cross section orthogonal to the flow path direction of the pillar shaped honeycomb segment 15, and multiplying it by 100. It should be noted that when calculating the opening ratio of the cells 13, the pair of electrodes 20a, 20b, and the functional material-containing layer 30 are not taken into account.

The partition walls 14 forming the pillar shaped honeycomb segment 15 are made of a material that can be heated by electric conduction, specifically made of a material having a PTC (Positive Temperature Coefficient) property. Further, the outer peripheral wall 11 may also be made of the material having the PTC property, as with the partition walls 14, as needed. By such a configuration, the functional material-containing layer 30 can be heated by heat transfer from the heat-generating partition walls 14 (and optionally the outer peripheral wall 11). Further, the material having the PTC property has characteristics such that when the temperature increases to exceed the Curie point, the resistance value is sharply increased, resulting in a difficult for electricity to flow. Therefore, when the temperature of the heater element 100 becomes high, the partition walls 14 (and the outer peripheral wall 11 if necessary) limit the current flowing through them, thereby suppressing excessive heat generation of the heater element 100. Therefore, it is possible to suppress thermal deterioration of the functional material-containing layer 30 due to excessive heat generation.

The lower limit of the volume resistivity at 25° C. of the material having the PTC property is preferably 0.5 Ω·cm or more, and more preferably 1 Ω·cm or more, and even more preferably 5 Ω·cm or more, from the viewpoint of obtaining appropriate heat generation. The upper limit of the volume resistivity at 25° C. of the material having the PTC property is preferably 20 Ω·cm or less, and more preferably 18 Ω·cm or less, and even more preferably 16 Ω·cm or less, from the viewpoint of generating heat with a low driving voltage.

As used herein, the volume resistivity at 25° C. of the material having the PTC property is measured according to JIS K 6271: 2008.

From the viewpoints that can be heated by electric conduction and has the PTC property, the partition walls 14 (and optionally the outer peripheral wall 11) are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can also be measured by the same method.

The compositional formula of BaTiO₃-based crystalline particles, in which a part of Ba is substituted with the rare earth element, can be expressed as (Ba₁₋ₓAₓ) TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer peripheral wall 11 and the partition walls 14 are substantially free of lead (Pb). More particularly, the outer peripheral wall 11 and the partition walls 14 preferably have a Pb content of 0.01% by mass or less, and more preferably 0.001% by mass or less, and still more preferably 0% by mass. The lower Pb content can allow the air heated by contact with the heat-generating partition walls 14 to be safely applied to organisms such as humans, for example. In the outer peripheral wall 11 and the partition walls 14, the Pb content is preferably less than 0.03% by mass, and more preferably less than 0.01% by mass, and further preferably 0% by mass, as converted to PbO. The lead content can be determined by ICP-MS (inductively coupled plasma mass spectrometry).

The material making up the outer peripheral wall 11 and the partition walls 14 preferably have a lower limit of a Curie point of 100° C. or more, and more preferably 110° C. or more, and even more preferably 125° C. or more, in terms of efficiently heating the air. Further, the upper limit of the Curie point is preferably 250° C. or more, and preferably 225° C. or more, and even more preferably 200° C. or more, and still more preferably 150° C. or more, in terms of safety as a component placed in the vehicle interior or near the vehicle interior.

The Curie point of the material making up the outer peripheral wall 11 and the partition walls 14 can be adjusted by the type of shifter and an amount of the shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### <Joining Layer 16>

The Joining layers 16 making up the honeycomb structure 10 are portions that join the surfaces of the outer peripheral walls 11 parallel to the extending direction of the cells 13 of the plurality of pillar shaped honeycomb segments 15.

The joining layer 16 is a layer formed using a joining material. Therefore, the joining layer 16 is a hardened layer of the joining material.

The joining layer 16 may contain the same material as the outer peripheral wall 11 and the partition walls 14. That is, the joining layer 16 can be made of a material which can generate heat by electric conduction, and specifically, which can be made of a material having the PTC property.

The joining material making up the joining layer 16 can be a paste obtained by adding a solvent such as water to a ceramic raw material.

The joining layers 16 have a thickness of 1.0 to 5.0 mm, and preferably 2.0 to 4.0 mm. By controlling the thickness of the joining layers 16 within such a range, the electrical resistance can be reduced, so that the temperature increase time (the regeneration time of the functional material) can be shortened.

The thickness of the joining layer s16 refers to a length of a line segment that is across the joining layer 16 when connecting the centers of gravity of adjacent pillar shaped honeycomb segments 15 with the line segment in the cross section orthogonal to the flow path direction of the pillar shaped honeycomb segment 15. The thickness of the joining layers 16 refers to an average thickness of all the joining layers 16.

### <Honeycomb Structure 10>

The honeycomb structure 10 has the plurality of pillar shaped honeycomb segments 15 and the joining layers 16.

The number of pillar shaped honeycomb segments 15 forming the honeycomb structure 10 is not particularly limited, and it can be adjusted as appropriate depending on the sizes of the pillar shaped honeycomb segments 15 and the like.

For example, as shown in FIG. 1B, the honeycomb structure 10 can have four pillar shaped honeycomb segments 15. In this case, in each pillar shaped honeycomb segment 15, two of four surfaces (hereinafter referred to as “side surfaces”) of the outer peripheral wall 11 parallel to the extending direction of the cells 13 are joined to the side surface of the outer peripheral wall 11 of the other pillar shaped honeycomb segment 15 via the joining layer 16.

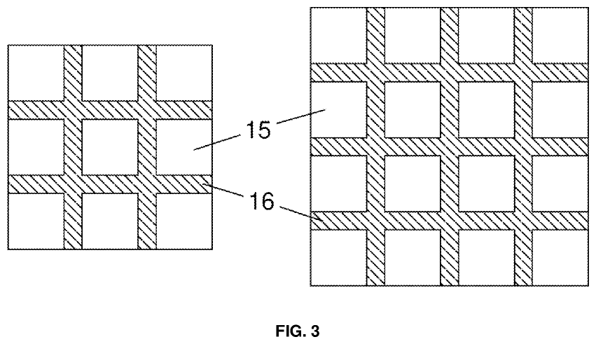

Further, as shown in FIG. 3, the honeycomb structure 10 may have nine (on the left side) or sixteen (on the right side) pillar shaped honeycomb segments 15. It should be note that, as with FIG. 1B, FIG. 3 is a schematic view of a cross section of the heater element, which is orthogonal to the extending direction of the cells 13 (flow path), and the detailed structures of the pilar shaped honeycomb segments 15 are omitted for the sake of clarity. When the honeycomb structure 10 has nine pillar shaped honeycomb segments 15, the two side surfaces of the four pillar shaped honeycomb segments 15 located at the outer peripheral corners, the three side surfaces of the four pillar shaped honeycomb segments 15 located at the outer periphery other than the outer peripheral corners, and the four side surfaces of one pillar shaped honeycomb segment 15 located at the central portion are joined to the side surfaces of the outer peripheral walls 11 of the other pillar shaped honeycomb segments 15 via the joining layers 16. Further, when the honeycomb structure 10 has sixteen pillar shaped honeycomb segments 15, the two side surfaces of the four pillar shaped honeycomb segments 15 located at the outer peripheral corners, the two side surfaces of the eight pillar shaped honeycomb segments 15 located at the outer periphery other than the outer peripheral corners, and the four side surfaces of the four pillar shaped honeycomb segments 15 located at the central portion are joined to the side surfaces of the outer peripheral walls 11 of the other pillar shaped honeycomb segments 15 via the joining layers 16.

The outer shape of the honeycomb structure 10 is not particularly limited. For example, an outer shape of a cross section of the honeycomb structure 10 orthogonal to the flow path direction (the extending direction of the cells 13) can be polygonal such as quadrangular (rectangular, square), pentagonal, hexagonal, heptagonal, and octagonal, circular, oval (egg-shaped, elliptical, elliptic, rounded rectangular, etc.), or the like.

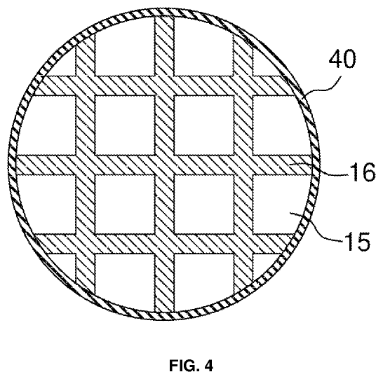

If a predetermined outer shape cannot be obtained by simply joining the side surfaces of the plurality of pillar shaped honeycomb segments 15 via the joining layers 16, the outer periphery may be processed into a desired shape by grinding or the like. For example, as shown in FIG. 4, when producing a cylindrical honeycomb structure 10 using pillar shaped honeycomb segments 15 each having a quadrangular pillar shape, the pillar shaped honeycomb structure 10 having the quadrangular pillar shape may be produced, and the outer periphery thereof may be then ground into a cylindrical shape. In this case, since the partition walls 14 and the cells 13 inside the pillar shaped honeycomb segments 15 become exposed by the processing, an outer peripheral coating layer 40 can be provided by covering the exposed surfaces with an outer peripheral coating material. The outer peripheral coating material that can be used includes the joining material used for forming the joining layer 16. It should be noted that, as with FIG. 1B, FIG. 4 is a schematic view of a cross section of the heater element, which is orthogonal to the extending direction of the cells 13 (flow path), and the detailed structures of the pillar shaped honeycomb segments are omitted for the sake of clarity.

A ratio of areas of the joining layers 16 to an area of the first end face 12a or the second end face 12b of the honeycomb structure 10 is not particularly limited, but it is preferably more than or equal to 1.9% and less than 28.6%, and more preferably 5.7 to 22.9%. By controlling the ratio of the areas of the joining layers 16 within such a range, the effect of shortening the temperature increase time (regeneration time of the functional material) by reducing the electrical resistance can be stably enhanced.

The length of the honeycomb structure 10 in the flow path direction and the cross-sectional area orthogonal to the flow path direction may be adjusted according to the required size of the heater element 100, and are not particularly limited. For example, when used in a compact heater element 100 while ensuring a predetermined function, the honeycomb structure 10 can have a length of 2 to 20 mm in the flow path direction and a cross-sectional area of 10 cm² (1000 mm²) or more orthogonal to the flow path direction. Although the upper limit of the cross-sectional area orthogonal to the flow path direction is not particularly limited, it is, for example, 300 cm² (30000 mm²) or less

### (1-2. A Pair of Electrodes)

A pair of electrodes 20a, 20b are provided on the first end face 12a and the second end face 12b.

Applying of a voltage between the pair of electrodes 20a, 20b allows the honeycomb structure 10 to generate heat by Joule heat.

The pair of electrodes 20a, 20b are not particularly limited, but if the partition walls 14 are made of a material containing barium titanate as a main component, the pair of electrodes 20a, 20b may preferably be made of a material having a lower electrical resistance than that of barium titanate. By forming the pair of electrodes 20a, 20b from the material having the lower electrical resistance than that of barium titanate, the effect of reducing electrical resistance can be improved, thereby increasing the effect of shortening the temperature increase time (the regeneration time of the functional material).

The pair of electrodes 20a, 20b may employ, for example, a metal or alloy containing at least one selected from Cu, Ag, Al, Ni and Si. It is also possible to use an ohmic electrode capable of ohmic contact with the outer peripheral wall 11 and/or the partition walls 14 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 20a, 20b may have a single-layer structure, or may have a laminated structure of two or more layers. When the pair of electrodes 20a, 20b have the laminated structure of two or more layers, the materials of the respective layers may be of the same type or of different types.

The thickness of the pair of electrodes 20a, 20b may be appropriately set according to the method for forming the pair of electrodes 20a, 20b. The method for forming the pair of electrodes 20a, 20b includes metal deposition methods such as sputtering, vapor deposition, electrolytic deposition, and chemical deposition. Alternatively, the pair of electrodes 20a, 20b can be formed by applying an electrode paste and then baking it, or by thermal spraying. Furthermore, the pair of electrodes 20a, 20b may be formed by joining metal sheets or alloy sheets.

Each of the thicknesses of the pair of electrodes 20a, 20b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each of the thicknesses is preferably about 5 to 100 μm.

### (1-3. Functional Material-Containing Layer)

The functional material-containing layer 30 is provided on the surfaces of the partition walls 14 (in the case of the outermost cells 13, the partition walls 14 that define the outermost cells 13 and the outer peripheral wall 11) parallel to the extending direction of the cells 13. By thus providing the functional material-containing layer 30, the functional material can be easily heated, so that the functional material can exert its desired function.

The functional material contained in the functional material-containing layer 30 is not particularly limited as long as it is a material that can exhibit a desired function, and examples that can be used herein include adsorbents, catalysts, and the like. The adsorbent preferably has a function of adsorbing one or more components selected from components to be removed in the air, such as water vapor, carbon dioxide, and volatile components. Also, the use of the catalyst can purify the components to be removed. Furthermore, the adsorbent and the catalyst may be used together for the purpose of enhancing the function of the absorbent to capture the components to be removed.

The adsorbent preferably has a function that can adsorb the components to be removed, such as water vapor, carbon dioxide and volatile components at −20 to 40° C. and release them at an elevated temperature of 60° C. or more. Examples of the adsorbent having such functions include zeolite, silica gel, activated carbon, alumina, silica, low-crystalline clay, amorphous aluminum silicate complexes, and the like. The type of the adsorbent may be appropriately selected depending on the types of the components to be removed. The adsorbent may be used alone, or in combination with two or more types.

The catalyst preferably has a function capable of promoting the oxidation-reduction reaction. The catalysts having such functions include metal catalysts such as Pt, Pd and Ag, and oxide catalysts such as CeO₂ and ZrO₂. The catalyst may be used alone, or in combination with two or more types.

The volatile components contained in the air in the vehicle interior include, for example, volatile organic compounds (VOCs), and odor components other than the VOCs Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the functional material-containing layer 30 may be determined according to the size of the cells 13, and is not particularly limited. For example, the thickness of the functional material-containing layer 30 is preferably 20 μm or more, and more preferably 25 μm or more, and even more preferably 30 μm or more, from the viewpoint of ensuring sufficient contact with air. On the other hand, the thickness of the functional material-containing layer 30 is preferably 400 μm or less, and more preferably 380 μm or less, and even more preferably 350 μm or less, from the viewpoint of suppressing separation of the functional material-containing layer 30 from the partition walls 14 and the outer peripheral wall 11.

The thickness of the functional material-containing layer 30 is measured using the following procedure. Any cross section parallel to the flow path direction of the honeycomb structure 10 is cut out, and a cross-sectional image at magnifications of about 50 is acquired using a scanning electron microscope or the like. Also, this cross section is made to pass through the center of gravity position in the cross section orthogonal to the flow path of the honeycomb structure 10. The thickness of each functional material-containing layer 30 visually recognized from the cross-sectional image is calculated by dividing the cross-sectional area by the length of the cells 13 in the flow path direction. This calculation is performed for all the functional material-containing layers 30 visually recognized from the cross-sectional image, and an average value thereof is determined to be the thickness of the functional material-containing layer 30.

From the viewpoint that the functional material exhibits a desired function in the heater element 100, an amount of the functional material-containing layer 30 is preferably 50 to 500 g/L, and more preferably 100 to 400 g/L, and even more preferably 150 to 350 g/L, based on the volume of the honeycomb structure 10. It should be noted that the volume of the honeycomb structure 10 is a value determined by the external dimensions of the honeycomb structure 10.

### (2. Method for Producing Heater Element)

The method for producing the heater element 100 according to the embodiment of the present invention is not particularly limited as long as it is the method that can produce the heater element 100 having the above features, and it can be performed according to a known method. Hereinafter, the method for producing the heater element 100 according to an embodiment of the present invention will be illustratively described.

A method for producing the pillar shaped honeycomb segments 15 used for the honeycomb structure 10 forming the heater element 100 includes a forming step and a firing step.

In the forming step, a green body containing a ceramic raw material including BaCO₃ powder, TiO₂ powder, and rare earth nitrate or hydroxide powder is formed to prepare a pillar shaped honeycomb segment formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the pillar shaped honeycomb segment formed body is 60% or more.

As used herein, the “relative density of the pillar shaped honeycomb segment formed body” means a ratio of the density of the pillar shaped honeycomb segment formed body to the true density of the entire ceramic raw material. More particularly, the relative density can be determined by the following equation: relative density of pillar shaped honeycomb segment formed body (%)=density of pillar shaped honeycomb segment formed body (g/cm³)/true density of entire ceramic raw material (g/cm³)×100.

The density of the pillar shaped honeycomb segment formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The pillar shaped honeycomb segment formed body can be produced by extrude the green body. In the extrusion, a die having a desired overall shape, cell shape, partition wall thickness, cell density and the like can be used.

The relative density of the pillar shaped honeycomb segment formed body obtained by extrusion is 60% or more, and preferably 65% or more. By controlling the relative density of the pillar shaped honeycomb segment formed body to such a range, the pillar shaped honeycomb segment formed body can be densified and the electrical resistance at room temperature can be reduced. The upper limit of the relative density of the pillar shaped honeycomb segment formed body is not particularly limited, but it may generally be 80%, and preferably 75%.

The pillar shaped honeycomb segment formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the pillar shaped honeycomb segment formed body at a temperature of from 1150 to 1250° C., and then increasing the temperature to a maximum temperature of from 1360 to 1430° ° C. at a heating rate of 20 to 600° C./hour, and maintaining the temperature for 0.5 to 10 hours.

The maintaining of the pillar shaped honeycomb segment formed body at the maximum temperature of from 1360 to 1430° C. for 0.5 to 10 hours can provide the honeycomb structure 10 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the pillar shaped honeycomb segment 15 can be densified.

Further, the heating rate of 20 to 600° C./hour from the temperature of 1150 to 1250° C. to the maximum temperature of 1360 to 1430° C. can allow 1.0 to 10.0% by mass of Bas Ti₁₇O₄₀ crystal particles to be formed into the pillar shaped honeycomb segment 15.

The maintaining time at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining at 900 to 950° C. for 0.5 to 5 hours during the increasing of the temperature. The maintaining at 900 to 950° C. for 0.5 to 5 hours can lead to sufficient decomposition of BaCO₃, so that the pillar shaped honeycomb segment 15 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

A paste-like joining material is then prepared by adding a solvent such as water to a ceramic raw material containing BaCO₃ powder and TiO₂ powder.

The joining material is then applied to the side surfaces of the pillar shaped honeycomb segments 15 obtained above, and joined to the side surfaces of the other pillar shaped honeycomb segments 15. During the joining, the side surfaces of the pillar shaped honeycomb segments 15 may be pressure-joined together by applying a pressure from the outside, if necessary. For the joining, for example, the joining material is cured to form the joining layers 16 by heating at 250 to 300° C. for about one hour.

By forming a pair of electrodes 20a, 20b on the honeycomb structure 10 obtained as described above, the heater element 100 can be produced.

The pair of electrodes 20a, 20b can be formed by metal deposition methods such as sputtering, vapor deposition, electrolytic deposition, and chemical deposition. Further, the pair of electrodes 20a, 20b can also be formed by applying an electrode paste and then baking it. Furthermore, the pair of electrodes 20a, 20b can also be formed by thermal spraying. The pair of electrodes 20a, 20b may be composed of a single layer, but may also be composed of a plurality of electrode layers having different compositions. A typical method for forming the pair of electrodes 20a, 20b will be described below.

First, an electrode slurry containing an electrode material, an organic binder, and a dispersion medium is prepared, and the surfaces of the outer peripheral wall 11, the partition walls 14 and the joining layers 16 on the first end face 12a or the second end face 12b of the honeycomb structure 10 are coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 10 is removed by blowing and wiping. The slurry can be then dried to form the pair of electrodes 20a, 20b on the first end face 12a or the second end face 12b of the honeycomb structure 10. The drying can be performed while heating the heater element 100 to a temperature of about 120 to 600° C., for example. Although a series of steps of coating, slurry removal, and drying may be performed only once, the steps can be repeated multiple times to provide the pair of electrodes 20a, 20b having desired thicknesses.

The functional material-containing layer 30 can be then formed on the surfaces of the partition walls 14 and the like of the heater element 100 thus obtained to provide the heater element 100 with the functional material-containing layer 30.

Although the method for forming the functional material-containing layer 30 is not particularly limited, it can be formed, for example, by the following steps. The heater element 100 is immersed in a slurry containing a functional material, an organic binder, and a dispersion medium for a predetermined period of time, and an excess slurry on the end faces and the outer periphery of the honeycomb structure 10 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the functional material-containing layer 30 on the surfaces of the partition walls 14. The drying can be performed while heating the heater element 100 to a temperature of about 120 to 600° C., for example. Although a series of steps of immersion, slurry removal, and drying may be performed only once, the steps can be repeated multiple times to provide the functional material-containing layer 30 having the desired thickness on the surfaces of the partition walls 14 and the like.

### EXAMPLES

Hereinafter, the present invention will be described in more detail with reference to Examples, but the present invention is not limited to these Examples.

### Examples

As ceramic raw materials, BaCO₃ powder, TiO₂ powder and La(NO₃)₃·6H₂O powder were prepared. These powders were weighed so as to have the predetermined composition after firing, and dry-mixed to obtain a mixed powder. The dry mixing was carried out for 30 minutes. Subsequently, 3 to 30 parts by weight of water, a binder, a plasticizer and a dispersant in total were added by a proper amount, based on 100 parts by mass of the obtained mixed powder, such that a pillar shaped honeycomb segment formed body having a relative density of 64.8% were obtained after extrusion, and then kneaded to obtain a green body. Methyl cellulose was used as the binder. Polyoxyalkylene alkyl ether was used as the plasticizer and the dispersant.

The obtained green body was then introduced into an extrusion molding machine and extruded using a predetermined die to obtain a pillar shaped honeycomb segment having the shape as shown below after the firing.

Shape of the cross section and each end face of the pillar shaped honeycomb segment orthogonal to the flow path direction: quadrangular;

Shape of the cross section of each cell of the pillar shaped honeycomb segment orthogonal to the flow path direction: quadrangular;

Thickness of the outer peripheral wall of the pillar shaped honeycomb segment: 0.127 mm;

Cell pitch of the pillar shaped honeycomb segment: 1.08 mm;

Length of the pillar shaped honeycomb segment in the extending direction of the flow path: 10 mm;

Volume resistivity at 25° C. of the material forming the outer peripheral wall and the partition walls of the pillar shaped honeycomb segment: 15 Ω·cm;

Curie point of the material forming the outer peripheral wall and the partition walls of the pillar shaped honeycomb segment: 120° C.; and

Other characteristics of the pillar shaped honeycomb segment: shown in Table 1.

Subsequently, after dielectric drying and hot air drying of the obtained pillar shaped honeycomb segment formed body, it was degreased in an air atmosphere in a firing furnace (at 450° C. for 4 hours), and then fired in an air atmosphere to obtain a pillar shaped honeycomb segment. The firing was carried out by maintaining it at 950° C. for 1 hour, and then increasing the temperature to 1200° C. and maintaining it at 1200° C. for 1 hour, and then increasing the temperature at a heating rate of 200° C./hour to 1400° C. (the maximum temperature) and maintaining it at 1400° C. for 2 hours.

A paste-like joining material was then prepared by adding water to a ceramic raw material containing BaCO₃ powder and TiO₂ powder. The joining material was applied to the side surface of the pillar shaped honeycomb segment so as to have the thickness shown in Table 1 after curing, and joined to the side surface of another pillar shaped honeycomb segment. This step was repeated to join 2 vertical and 2 horizontal pillar shaped honeycomb segments, vertical 3 and horizontal 3 pillar shaped honeycomb segments, and vertical 4 and horizontal 4 pillar shaped honeycomb segments. During the joining, the pillar shaped honeycomb segments were pressed together by applying a pressure from the outside and heated at 250 to 300° C. for about 1 hour to obtain a honeycomb structure.

The pair of electrodes were then formed on both end faces (first end face and second end face) of the obtained honeycomb structure. The pair of electrodes were formed as follows. First, an electrode slurry containing aluminum (electrode material), ethyl cellulose, and diethylene glycol monobutyl ether (organic binder) was prepared, and one first end face was coated with the slurry. Subsequently, after removing an excess electrode slurry on the outer periphery of the honeycomb structure by blowing and wiping, the electrode slurry was dried to form the electrode on the one end face. In the same way, the electrode was also formed on the other end face to form a heater element.

### Comparative Example

As a comparative example, a heating element was obtained by producing a general honeycomb structure without a joining layer and forming a pair of electrodes on both end faces of the honeycomb structure. The materials used in this comparative example are the same as above. Also, the structural features of the heater element of this comparative example are basically the same as those described above with the exception that it does not have the joining layer.

The heater elements thus obtained were evaluated as follows:

### <Temperature Increase Property>

The time until the temperature reaches 80° C. when a voltage of 12 V was applied to the heater element 100 was measured. The measurement of the temperature was performed using thermocouples at five positions (one position at the central portion and four positions at the outer periphery of the cross section orthogonal to the extending direction of the cells (flow path) of the honeycomb structure forming the heater element). It should be noted that the temperature was an average of the temperatures at the five positions. In this evaluation, a sample in which the time to reach the temperature was within 185 seconds is represented as A, and a sample to reach the temperature exceeded 185 seconds is represented as B.

### <Pressure Loss>

Differential pressure gauges were installed on upstream and downstream sides of each sample, air was passed through at a flow rate of 45 m³/h, and a pressure loss (pressure on upstream side−pressure on downstream side) was determined. In this evaluation, a rate of change in pressure loss was determined using the following equation using the pressure loss of Comparative Example as a reference.

$$\\ Rate of change in pressure loss [ \% ] = ( \begin{matrix}1 - ( pressure loss in Comparative Example ) / \\ ( Pressure Loss in Example )\end{matrix} ) \times 100$$

In this evaluation, it can be said that as the rate of change in pressure loss [%] is smaller, the pressure loss is better. Also, in this evaluation, a sample in which the rate of change in pressure loss [%] was 41.0% or less is represented as A, and a sample in which the rate of change in pressure loss [%] exceeded 41.0% is represented as B.

TABLE 1

| Pillar Shaped Honeycomb Segment *1) | | | | Joining | Each End Face of Honeycomb Structure | | | | | | | |
|---|---|---|---|---|---|---|---|---|---|---|---|---|
| | Partition | | | Layer | | Area of | | Temper- | Pressure Loss | | | |
| | Wall | | Opening | Thick- | Total | Joining | Area Ratio | ature | Measured | Rate of | | |
| | Thickness | Cell Density | Ratio | ness | Area | Layer | of Joining | Increase | Value | Change | Evalu- | |
| Number | [mm] | (cells/cm²) | [%] | [mm] | [mm²] | [mm²] | Layer[%] | Property | [Pa] | [%] | ation | Section |
| — | 0.1397 | 93.0 | 76.4 | — | 11074 | — | — | B | 103.6 | — | — | Comp |
| 2 × 2 | 0.1397 | 93.0 | 71.7 | 1 | 11074 | 211 | 1.9 | A | 107.0 | 3.2 | A | Ex. |
| | | | | 2 | | 422 | 3.8 | A | 111.4 | 7.0 | A | Ex. |
| | | | | 3 | | 633 | 5.7 | A | 116.0 | 10.7 | A | Ex. |
| | | | | 4 | | 844 | 7.6 | A | 121.1 | 14.5 | A | Ex. |
| | | | | 5 | | 1055 | 9.5 | A | 126.9 | 18.4 | A | Ex. |
| | 0.1270 | 85.3 | 75 | 1 | 11074 | 211 | 1.9 | A | 76.5 | −35.4 | A | Ex. |
| | | | | 2 | | 422 | 3.8 | A | 79.1 | −31.0 | A | Ex. |
| | | | | 3 | | 633 | 5.7 | A | 82.0 | −26.3 | A | Ex. |
| | | | | 4 | | 844 | 7.6 | A | 85.2 | −21.6 | A | Ex. |
| | | | | 5 | | 1055 | 9.5 | A | 88.8 | −16.7 | A | Ex. |
| | 0.1016 | 77.5 | 80.3 | 1 | 11074 | 211 | 1.9 | A | 48.5 | −113.8 | A | Ex. |
| | | | | 2 | | 422 | 3.8 | A | 49.9 | −107.6 | A | Ex. |
| | | | | 3 | | 633 | 5.7 | A | 51.4 | −101.6 | A | Ex. |
| | | | | 4 | | 844 | 7.6 | A | 53.1 | −95.1 | A | Ex. |
| | | | | 5 | | 1055 | 9.5 | A | 55.0 | −88.4 | A | Ex. |
| 3 × 3 | 0.1397 | 93.0 | 71.7 | 1 | 11074 | 422 | 3.8 | A | 111.4 | 7.0 | A | Ex. |
| | | | | 2 | | 844 | 7.6 | A | 121.1 | 14.5 | A | Ex. |
| | | | | 3 | | 1266 | 11.4 | A | 133.4 | 22.3 | A | Ex. |
| | | | | 4 | | 1688 | 15.2 | A | 149.5 | 30.7 | A | Ex. |
| | | | | 5 | | 2110 | 19.1 | A | 171.4 | 39.5 | A | Ex. |
| | 0.1270 | 85.3 | 75 | 1 | 11074 | 422 | 3.8 | A | 79.1 | −31.0 | A | Ex. |
| | | | | 2 | | 844 | 7.6 | A | 85.2 | −21.6 | A | Ex. |
| | | | | 3 | | 1266 | 11.4 | A | 92.8 | −11.6 | A | Ex. |
| | | | | 4 | | 1688 | 15.2 | A | 102.5 | −1.1 | A | Ex. |
| | | | | 5 | | 2110 | 19.1 | A | 115.4 | 10.2 | A | Ex. |
| | 0.1016 | 77.5 | 80.3 | 1 | 11074 | 422 | 3.8 | A | 49.9 | −107.6 | A | Ex. |
| | | | | 2 | | 844 | 7.6 | A | 53.1 | −95.1 | A | Ex. |
| | | | | 3 | | 1266 | 11.4 | A | 57.1 | −81.4 | A | Ex. |
| | | | | 4 | | 1688 | 15.2 | A | 62.1 | −66.8 | A | Ex. |
| | | | | 5 | | 2110 | 19.1 | A | 68.4 | −51.5 | A | Ex. |
| 4 × 4 | 0.1397 | 93.0 | 71.7 | 1 | 11074 | 633 | 5.7 | A | 116.0 | 10.7 | A | Ex. |
| | | | | 2 | | 1266 | 11.4 | A | 133.4 | 22.3 | A | Ex. |
| | | | | 3 | | 1899 | 17.1 | A | 159.6 | 35.1 | A | Ex. |
| | | | | 4 | | 2532 | 22.9 | A | 175.2 | 40.9 | A | Ex. |
| | | | | 5 | | 3165 | 28.6 | A | 285.6 | 63.7 | B | Ex. |
| | 0.1270 | 85.3 | 75 | 1 | 11074 | 633 | 5.7 | A | 82.0 | −26.3 | A | Ex. |
| | | | | 2 | | 1266 | 11.4 | A | 92.8 | −11.6 | A | Ex. |
| | | | | 3 | | 1899 | 17.1 | A | 108.5 | 4.5 | A | Ex. |
| | | | | 4 | | 2532 | 22.9 | A | 133.0 | 22.1 | A | Ex. |
| | | | | 5 | | 3165 | 28.6 | A | 176.5 | 41.3 | B | Ex. |
| | 0.1016 | 77.5 | 80.3 | 1 | 11074 | 633 | 5.7 | A | 51.4 | −101.6 | A | Ex. |
| | | | | 2 | | 1266 | 11.4 | A | 57.1 | −81.4 | A | Ex. |
| | | | | 3 | | 1899 | 17.1 | A | 65.0 | −59.4 | A | Ex. |
| | | | | 4 | | 2532 | 22.9 | A | 76.8 | −34.9 | A | Ex. |
| | | | | 5 | | 3165 | 28.6 | A | 95.9 | −8.0 | A | Ex. |

*1) For Comparative Example, the pillar shaped honeycomb segment is read as a honeycomb structure.

As shown in Table 1, the heater elements according to Examples each using the honeycomb structure in which the pillar shaped honeycomb segments were joined by the joining layers, and controlling the thickness of the partition walls of each pillar shaped honeycomb segment to 0.1016 to 0.1397 mm, and the thickness of the joining layer to 1.0 to 5.0 mm, had the good temperature increase property.

As can be seen from the above results, according to the present invention, it is to provide a heater element for vehicle air conditioning, which can suppress an increase in electrical resistance and shorten the temperature increase time even if the thickness of the partition walls of the honeycomb structure is small.

### DESCRIPTION OF REFERENCE NUMERALS

10 honeycomb structure
11 outer peripheral wall
12a first end face
12b second end face
13 cell
14 partition wall
15 pillar shaped honeycomb segment
16 joining layer
20a, 20b electrode
30 functional material-containing layer
40 outer peripheral coating layer
100 heater element

1. A heater element for vehicle air conditioning, comprising:
a honeycomb structure comprising: a plurality of pillar shaped honeycomb segments each having an outer peripheral wall and partition walls disposed on an inner side of the outer peripheral wall, the partition walls defining a plurality of cells, each of the cells extending from a first end face to a second end face to form a flow path; and joining layers for joining surfaces of the outer peripheral walls of the plurality of pillar shaped honeycomb segments parallel to an extending direction of the cells; and
a pair of electrodes provided on surfaces of the outer peripheral wall, the partition walls and the joining layers on the first end face and the second end face;
wherein the partition walls have a thickness of 0.1016 to 0.1397 mm, and the joining layers have a thickness of 1.0 to 5.0 mm.

2. The heater element for vehicle air conditioning according to claim 1, wherein the pillar shaped honeycomb segments have an opening ratio of 71.7 to 80.3%.

3. The heater element for vehicle air conditioning according to claim 1, wherein a ratio of areas of the joining layers to an area of the first end face or the second end face of the honeycomb structure is more than or equal to 1.9% and less than 28.6%.

4. The heater element for vehicle air conditioning according to claim 1, wherein the partition walls are made of a material containing barium titanate as a main component.

5. The heater element for vehicle air conditioning according to claim 4, wherein the pair of electrodes are made of a material having a lower electrical resistance than that of the barium titanate.

6. The heater element for vehicle air conditioning according to claim 1, further comprising a functional material-containing layer provided on surfaces of the partition walls parallel to an extending direction of the cells.

7. The heater element for vehicle air conditioning according to claim 6, wherein the functional material-containing layer comprises a functional material having a function of adsorbing one or more selected from water vapor, carbon dioxide, and volatile components.

8. The heater element for vehicle air conditioning according to claim 6, wherein the functional material-containing layer comprises a catalyst.
